(19) United States
(12) Patent Application Publication
(10) Pub. No.: US 2005/0052065 A1
(43) Pub. Date: Mar. 10, 2005

(54) Motor vehicle rear-seat head-rest

(76) Inventors: Gerhard Rothstein, Velbert (DE); Jorg Linnenbrink, Wuppertal (DE)

Correspondence Address: Martin A Farber, Suite 473, 866 United Nations Plaza, New York, NY, 10017, US

(21) Appl. No.: 10/490,251

(22) PCT Filed: Sep. 24, 2002
(86) PCT No.: PCT/EP02/10690

(30) Foreign Application Priority Data
Sep. 25, 2001 (DE) 20116162.1
Aug. 2, 2002 (DE) 20211896.7
Sep. 18, 2002 (DE) 20214595.6

(51) Int. Cl. B60R 22/28

(52) U.S. Cl. 297/403

(57) ABSTRACT

A rear seat headrest (5) with adjustment mechanism for motor vehicles, wherein the headrest (5) can be pivoted about a pivot pin (24) out of a position of use into a concealed position using a weight force which is active on account of a weight of the headrest, and can be displaced by motor means at least out of the concealed position into the position of use, and wherein there is a spindle drive (20, 21) for displacing the headrest (5).

The invention relates to a rear seat headrest with adjustment mechanism for motor vehicles, wherein the headrest can be pivoted about a pivot pin out of a position of use into a concealed position using a weight force which is active on account of a weight of the headrest and can at least be displaced by motor means out of the concealed position into the position of use.

A rear seat headrest of this type is known from DE 35 45 142 A1. An advantage of a rear seat headrest of this type is that, for example when the rear seats are not occupied, the corresponding rear seat headrests, after they have been released, can pivot into a concealed position, and the driver is thereby ensured improved rear visibility. If the rear seats are occupied, the rear seat headrests which have been folded down can be moved out of the concealed position into the position of use. This is done by an electric motor which is associated with the headrest and to the output shaft of which a drive rod is rigidly secured. The latter, together with a coupling rocker which engages on a holding receptacle for the headrest, forms a toggle joint. In the position of use of the headrest, the toggle joint is approximately in a stretched position. With regard to buckling, this configuration is relatively unstable in use if relatively high loads occur. Furthermore, this configuration requires a relatively strong electric motor to enable the headrest to be moved into its different positions. Moreover, by way of example when the headrest adopts its position of use, any crash forces are transmitted into the motor shaft via the toggle joint, which adopts approximately a stretched position.

The subject matter of the invention is based on the object of making a rear seat headrest of the generic type more favorable in terms of control technology, and also of achieving a high degree of stability in use.

This object is achieved firstly and substantially in a rear seat headrest having the features of claim 1, in which a spindle drive is provided for displacing the headrest.

The subjects of the further claims are explained below with reference to the subject matter of claim 1 but may also be of importance in their independently formulated version.

According to a configuration of this nature, the invention provides a rear seat headrest of the generic type which, in addition to control engineering advantages, is also distinguished by greater safety in the event of high loads occurring. A spindle drive is now used to displace the headrest out of the position of use into the concealed position and back. Particularly sensitive, continuous adjustment can be carried out. To actuate the spindle drive, on the one hand the threaded spindle itself may be driven, or on the other hand it is also possible for a threaded nut located on the threaded spindle to be driven. The following text predominantly explains the first alternative in more detail. It is also possible for the driving electric motor to be in a fixed position or to pivot with the headrest. In this respect too, the following text explains the first alternative in more detail. The electric motor which drives the threaded spindle can be relatively weak. This leads to a physically compact structure and a weight saving. Moreover, the electric motor drive is configured in such a way that it is unaffected even by any high loads. In situations of this nature, the self-locking action of the spindle drive is utilized. By way of example, the spindle can be driven by means of a worm drive or a bevel gear drive. If a bevel gear drive is used, the ring gear can be seated on the spindle. This means that just a low motor power can be used to apply high adjustment forces. To minimize the driving forces required to adjust the headrest, the weight force of the headrest is opposed by a spring. In practice, this is such that when the headrest is being adjusted out of its position of use into the concealed position, which is associated with the headrest pivoting, the weight of the headrest is used to load the spring such that the latter acts in the manner of a force accumulator. In the concealed position of the headrest, therefore, the spring is loaded or stressed to the maximum degree. In the event of the headrest being displaced out of the concealed position into the position of use, therefore, this movement is boosted by the spring which has previously been loaded. Therefore, the drive substantially only has to overcome the friction in the system or in the spindle drive. This leads to a configuration of the drive with extremely small dimensions, which is eminently suitable for integration in an adjustable headrest. Furthermore, according to the invention it is provided that the spring moment resulting from the spring exceeds the moment which results from the weight force at least over part of the pivoting travel. Therefore, in the event of the spring action deteriorating, as occurs after prolonged use, equilibrium in the torques is still ensured. It is also ensured that in the initial displacement of the headrest out of the concealed position there is sufficient force to transfer the headrest into the position of use. The measure whereby the spring is a torsion spring has proven structurally expedient. Such a spring can be produced at low cost and can be accommodated in an expedient way in the adjustment mechanism. The measure whereby the spring is wound round the rotation pin has proved particularly advantageous. Accordingly, a component which is already present is used to hold the spring. Furthermore, according to the invention the spindle drive acts on the headrest at a transverse spacing from the pivot pin. A change in the transverse spacing is associated with a change in the position of the headrest. The holding brackets which are used as carriers for the headrest are, in accordance with the invention, secured in position by means of positively locking pins. Furthermore, the spindle drive acts on the holding brackets by means of the positively locking pins. Accordingly, the positively locking pins fulfill a dual function: firstly, they are used to secure the position of the holding brackets, and secondly they are used to position the latter with the headrest, so that either the position of use or the concealed position can be realized, depending on the position of the positively locking pins. As has already been mentioned, the spindle drive includes a spindle nut in which the positively locking pins are also secured. Consequently, synchronous displacement of the positively locking pins is ensured. If the spindle drive, starting from the position of use of the headrest, displaces the latter into the concealed position, the positively locking pins, in the concealed position, move into a spaced-apart position with respect to the holding brackets. Nevertheless, in the concealed position the headrest cannot trail further behind. This spaced-apart position is used to allow the headrest to be folded over further if the backrest is folded down after the seat part itself has previously been folded forward. This means that the headrest and/or its holding brackets can be pivoted further in the direction of the holding pins, for example in the event of the backrest on which the headrests are mounted being folded down. This further pivoting takes place, in accordance with the invention, counter to the force of a return spring. The headrest may also in its entirety, if appropriate together with drive, be fitted to a pivotable console. Furthermore, according to the invention, the holding brackets are inserted into holding receptacles. The latter can for their part be displaced about the pivot pin. Since loading forces which act on the headrest in its position of use are substantially absorbed by the positively locking pins, it is recommended for the holding receptacles to be made from plastic. This may even lead to additional yielding properties in the event of a crash, which contributes to minimizing the risk of injury. Furthermore, the fact that the holding receptacles on the pivot pin are spring-preloaded in the direction of engagement against the positively locking pins should also be noted. This ensures that the positively locking pins will engage against the holding receptacles in the intended way, in which position the positively locking pins are at the same time responsible for securing the position of the inserted holding brackets. If the headrest is to be removed, it can be taken hold of while the positively locking pins are moved a few degrees into a spaced-apart position by means of the spindle drive. As a result, the positively locking connection is released and the holding brackets can be pulled out of the holding receptacles. The spindle drive then opens up the option of adjusting the headrest by a few degrees as required. If the headrest is actuated so as to move into its concealed position, the positively locking pins move further after a defined angular position of the holding receptacles has been reached. The trailing movement is in this case limited by the force of the return spring, which force is greater than the spring force acting on the holding receptacles. According to the invention, a configuration which is highly advantageous in particular with regard to soiling is achieved by virtue of the holding receptacles forming insertion passages for the holding brackets, which insertion passages have radially recessed free spaces running in the longitudinal direction. These passages collect dust and dirt, so that such matter has no disadvantageous effects with regard to appropriate guidance of the holding brackets in the insertion passages. To ensure that the ends of the brackets are secured even when the positively locking pins move into the spaced-apart position with respect to the holding receptacles, a holding lever is provided which supplements a holding pin in order to secure a bracket in a positively locking manner. Therefore, if the positively locking pins leave their positively locking connection, the holding lever accordingly adopts its blocking function. In principle, it should be noted that adjustment of the rear seat headrest may also be effected automatically, for example by detection of occupancy of a seat in combination with actuation of a seatbelt catch. During the movement of the headrest into, for example, a receptacle in the parcel shelf, beyond a certain angle a spring spacing is introduced between the holding brackets and the positively locking pins. This is advantageously used to allow the headrest to be pushed over from, for example, 90° to 125° in the event of the backrest being folded down. Then, the user sitting on a rear seat of an automobile can adjust the headrest individually over a certain final adjustment range of the latter. This can be effected automatically by sensor interrogation. To open up a further adjustment option in the position of use of the rear seat headrest, the cushion body, which can move pivotably with the holding brackets to a limited extent, is spring-preloaded into a stop position, in such a manner that during the displacement of the headrest the cushion body can be adjusted by engaging against a pivot stop. In one configuration of the generic type, a further degree of freedom with regard to the adjustment options for the headrest is achieved by virtue of the fact that the cushion body can be displaced separately by means of a drive. In addition of pivoting adjustment of the headrest, it is also possible for the latter to be adjusted in the Z direction. This means that the user of the rear seat can set the headrest completely individually. The corresponding drive may in this case be configured as an electric motor. It is recommended that the latter be accommodated in the cushion body itself, so that after the holding brackets with headrests have been set by means of the spindle drive, it is possible to adjust the height of the cushion body on the ends of the holding brackets which are located within the cushion body. To ensure that the cushion body can always be moved into its concealed position in the prescribed manner even after adjustment by means of the drive at the cushion body, it is only possible for the headrest to be displaced into the concealed position when the cushion body is in its starting position. This can be implemented, for example, in conjunction with a seat occupancy detection. If the person sitting on a rear seat leaves the seat, this is communicated to the headrest control via the occupancy detection, so that first of all the cushion body moves into the starting position, and then the pivoting into the concealed position is initiated. A further embodiment of the rear seat headrest, in which the weight force of the headrest is opposed by a spring, is distinguished by the fact that the overall profile of the spring is of U-shaped configuration. In this case, it is provided that the U limbs interact with the pivot bearing, which carries the positively locking pins opposite the pivot pin, while the web of the U acts as a torsion bar and applies the spring force. Accordingly, the web of the U runs adjacent to the pivot pin, spatially parallel thereto. To achieve optimum spring mounting, according to the invention it is provided that the web of the U is longer than the limbs of the U. This is also optimized by virtue of the fact that the web of the U is enlarged by means of looped routing with respect to the active spring length. The loop in question can in this case also be used to fix the spring to the headrest holder, specifically by the spring being secured against rotation in the region of the loop. To compensate for any manufacturing and/or installation tolerances, the spindle is mounted with movement play with respect to the headrest holder. In a further version, it is possible, according to the invention for the headrest to pivot together with the holder. It is also possible, in a further configuration, for the spindle nut to be driven relative to the stationary spindle. A further advantageous feature consists in an insertion section being secured by a securing spring position disposed at the holding receptacle. In order, for example, to enable the cushion body to be removed together with the holding brackets, the securing spring should first be moved into a release position. This may advantageously be configured in such a way that the securing spring can be displaced into a release position with motor assistance.

Three exemplary embodiments of the invention are explained below with reference to the drawings, in which:

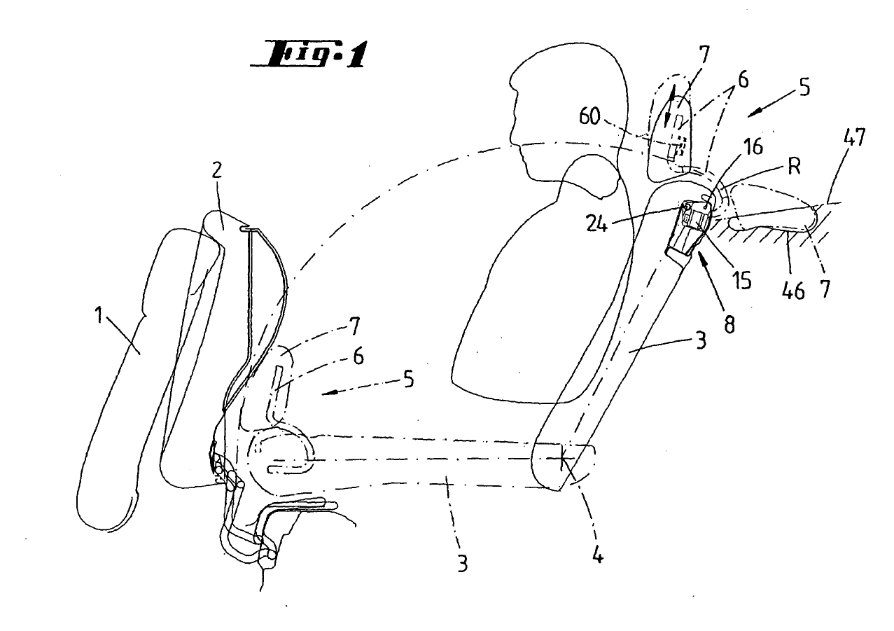

FIG. 1 diagrammatically depicts a rear seat headrest according to the invention in its position of use, relating to the first embodiment,

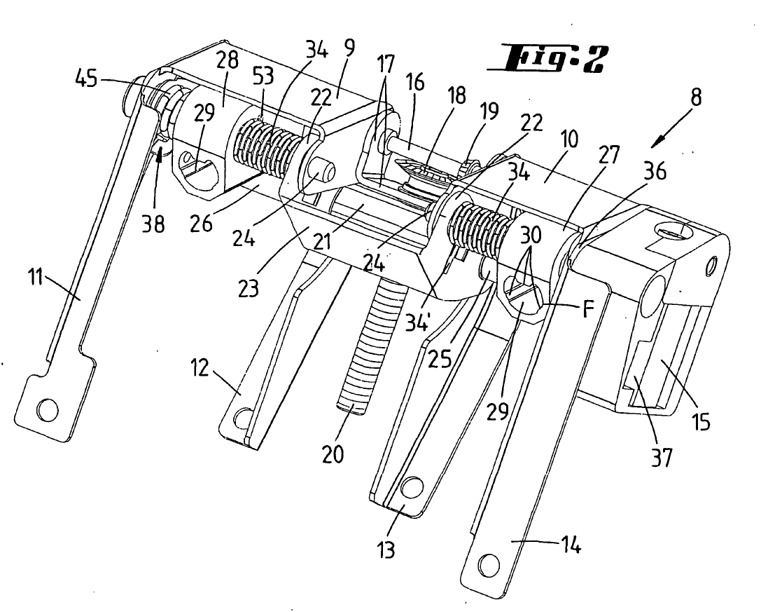

FIG. 2 shows a perspective illustration of the headrest holder corresponding to the position of use of the headrest,

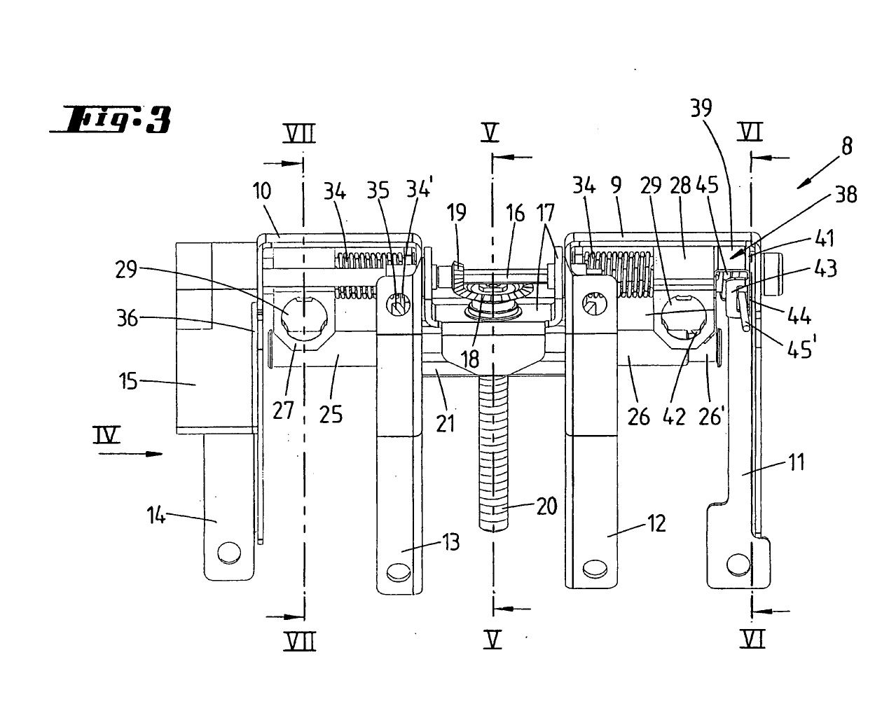

FIG. 3 shows a rear view of the headrest holder,

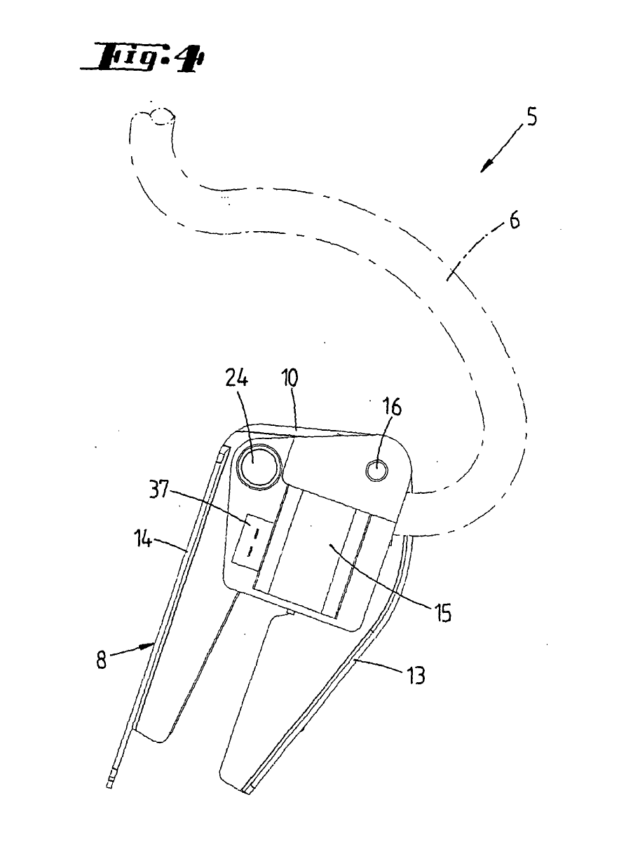

FIG. 4 shows a side view in the direction of arrow IV in FIG. 3,

FIG. 5 shows a section on line V-V in FIG. 3,

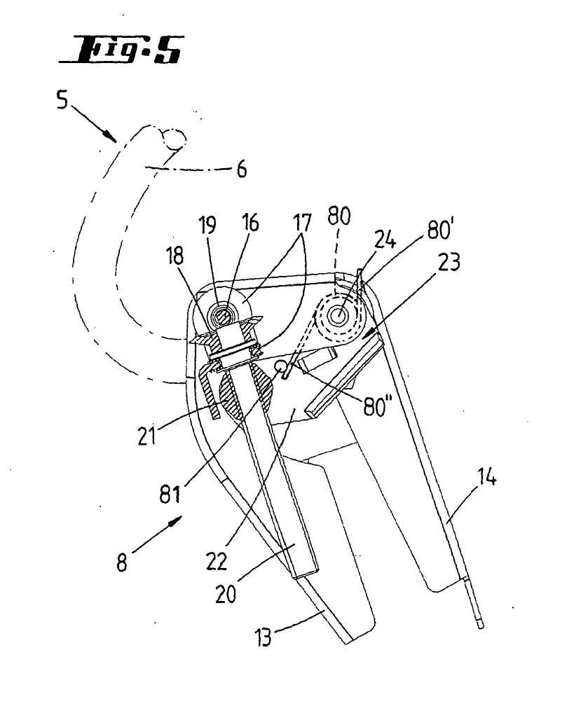

FIG. 6 shows a section on line VI-VI in FIG. 3,

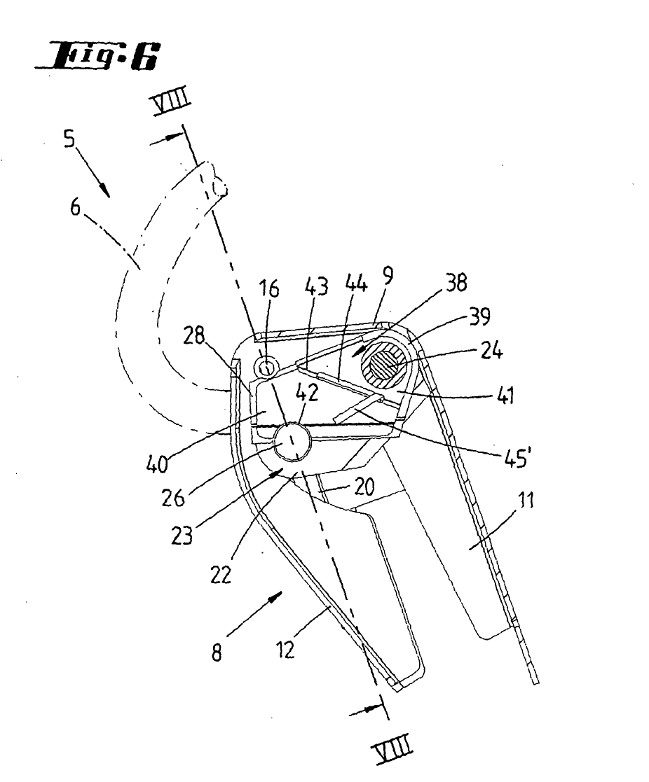

FIG. 7 shows a section on line VII-VII in FIG. 3,

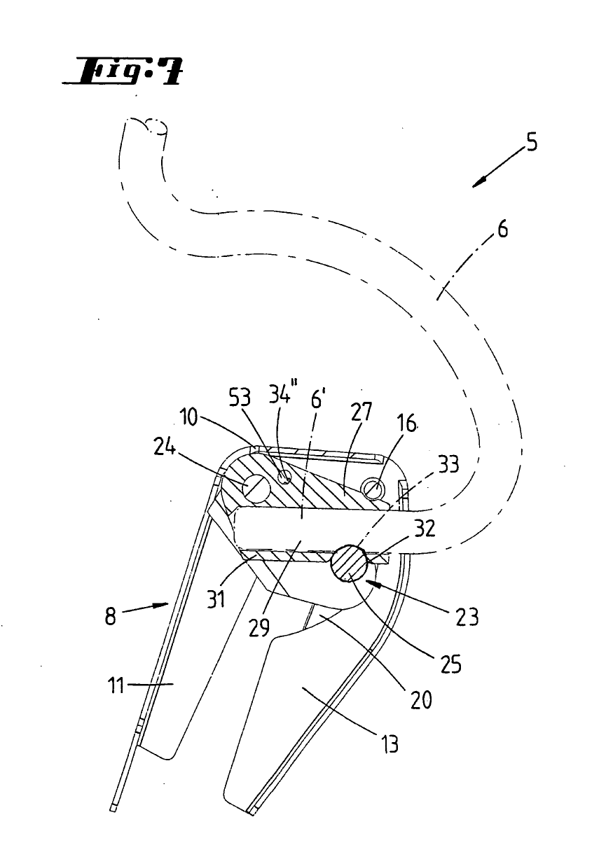

FIG. 8 shows a section on line VIII-VIII in FIG. 6,

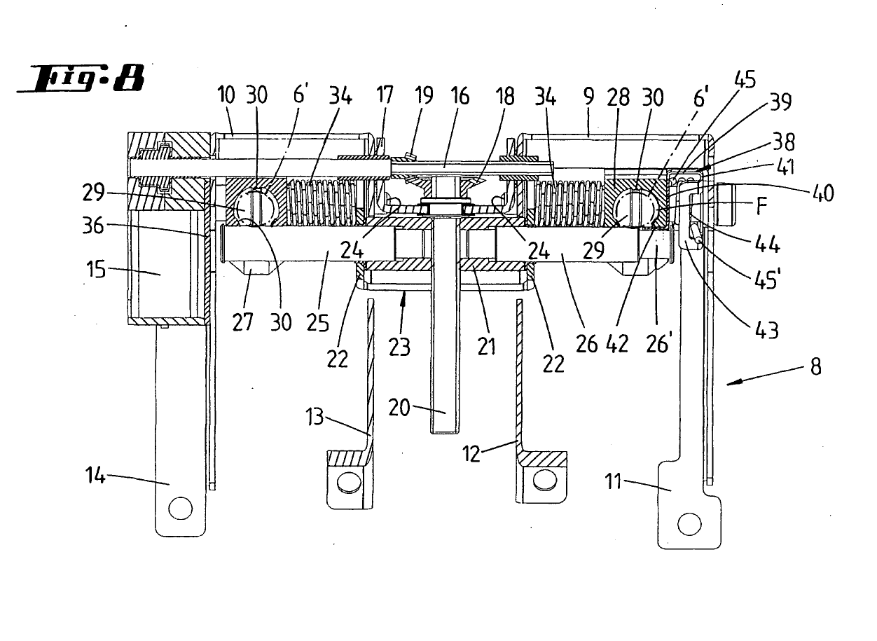

FIG. 9 shows an illustration corresponding to FIG. 2, in which both the positively locking pins and the holding receptacles for the holding brackets have been pivoted through approximately 90°,

FIG. 10 shows the same section as in FIG. 6 for this position,

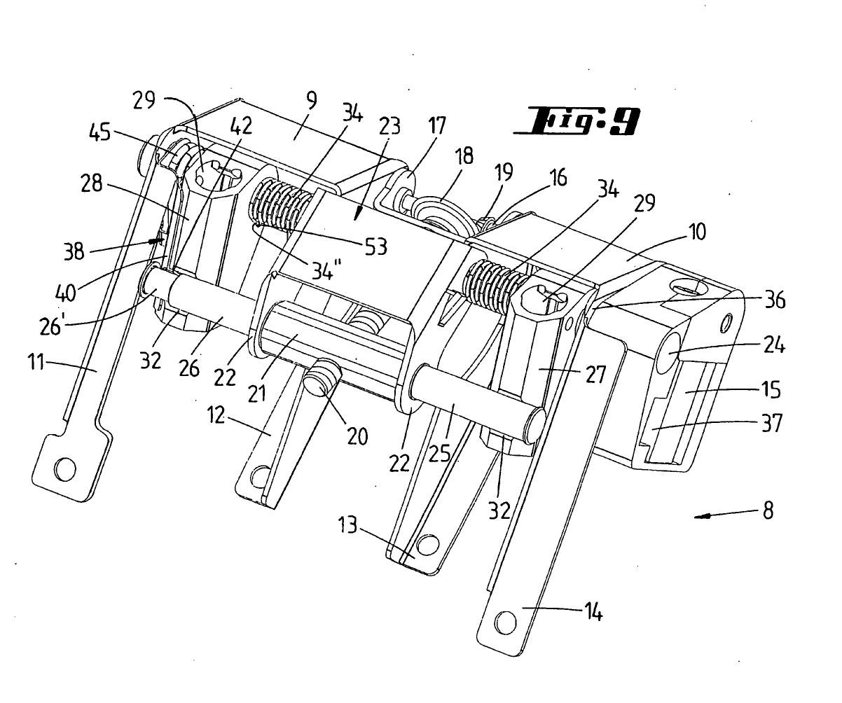

FIG. 11 shows the section similar to FIG. 7 for this position,

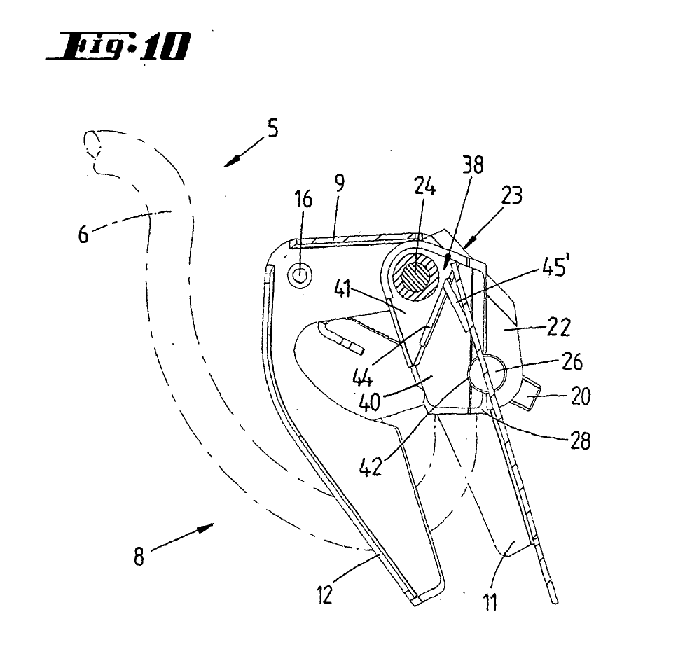

FIG. 12 shows the follow-up illustration to FIG. 9, in which the holding receptacles have remained in the 90° position, while the positively locking pins have been displaced through 125° about the pivot pin,

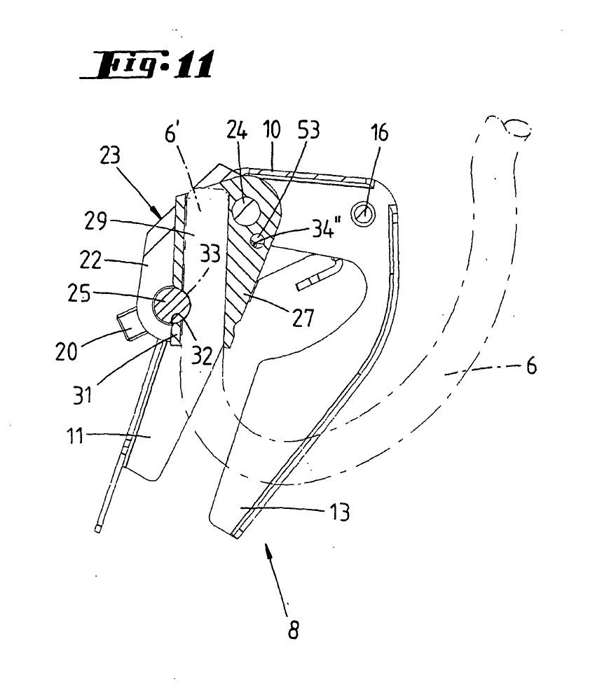

FIG. 13 shows the section similar to FIG. 10 for this position,

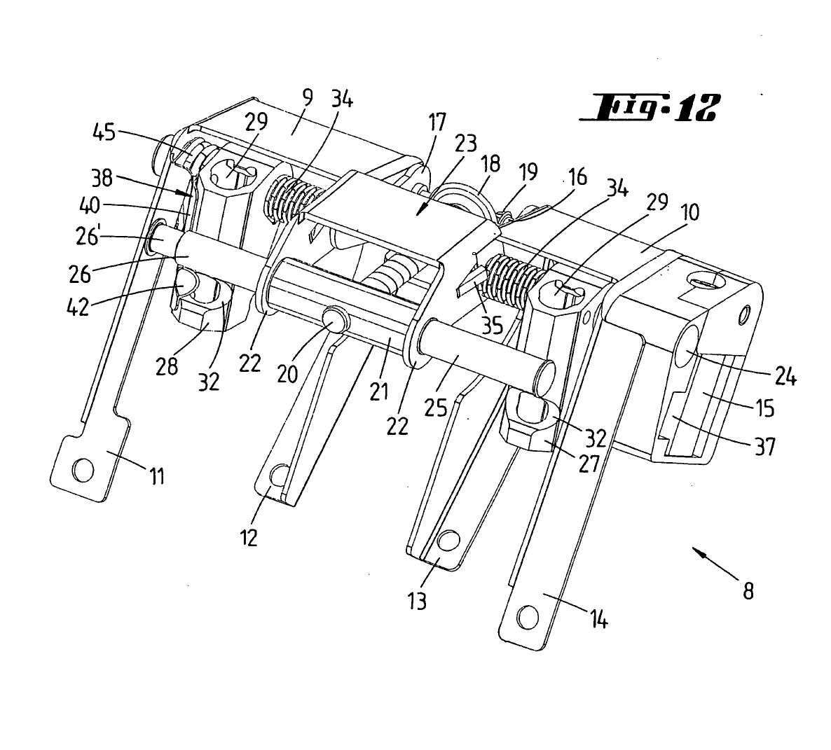

FIG. 14 shows the section corresponding to FIG. 11 for this position,

FIG. 15 shows a follow-up illustration to FIG. 12, in which both the positively locking pins and the holding receptacles have moved through approximately 125° about the pivot pin,

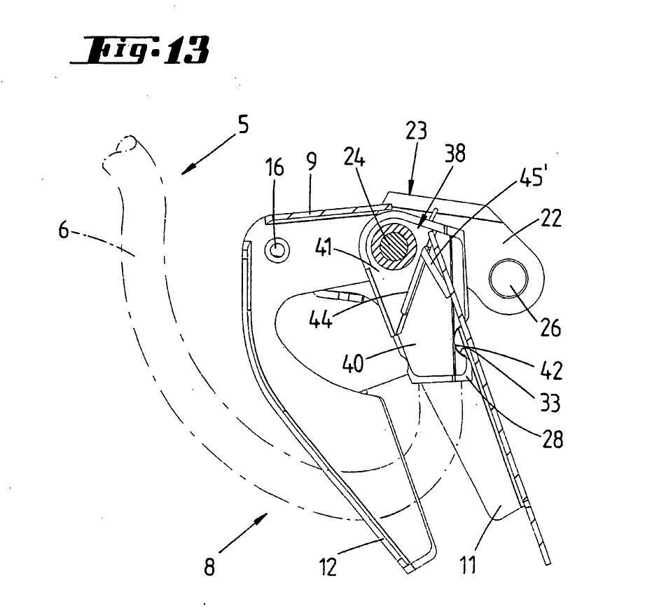

FIG. 16 shows the section similar to FIG. 13 for this position,

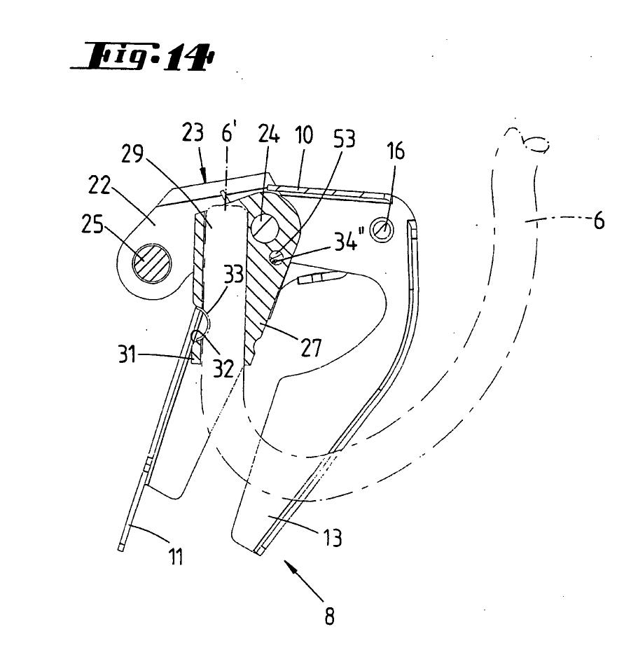

FIG. 17 shows the section similar to FIG. 14 for this position,

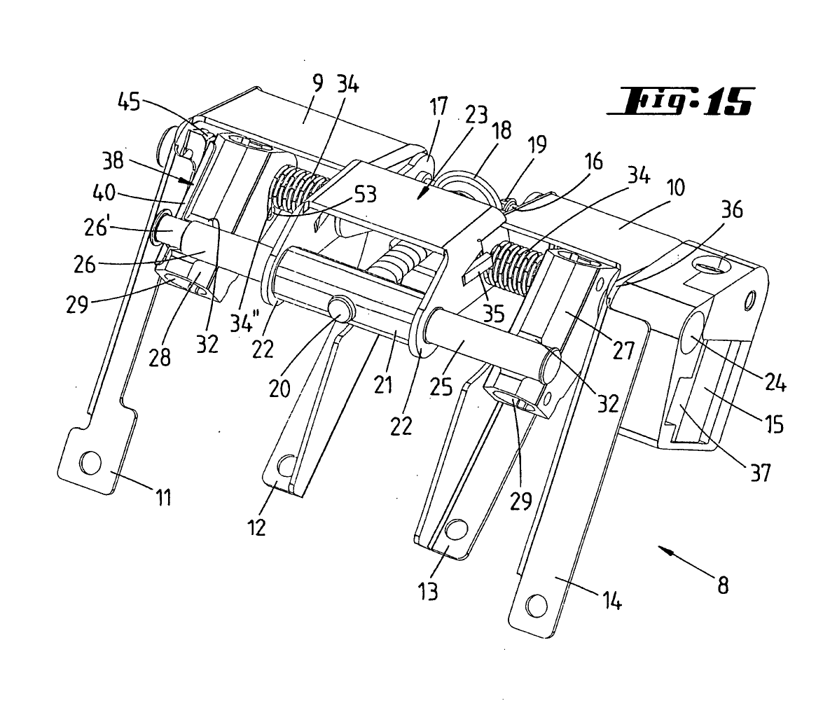

FIG. 18 shows a similar section to that shown in FIG. 6, except that, as a deviation from the position of use of the headrest, the positively locking pins have been displaced by a few degrees, so as to eliminate the positively locking connection,

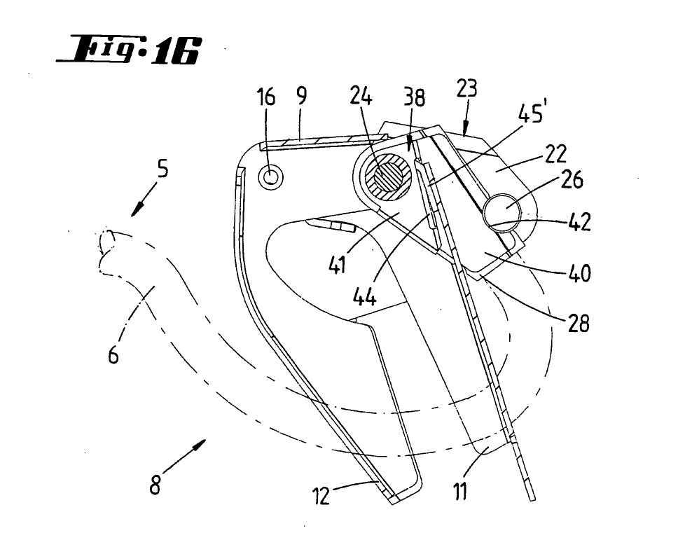

FIG. 19 shows the section similar to FIG. 7 for this position,

FIG. 20 diagrammatically depicts the cushion body which is spring-preloaded into a stop position,

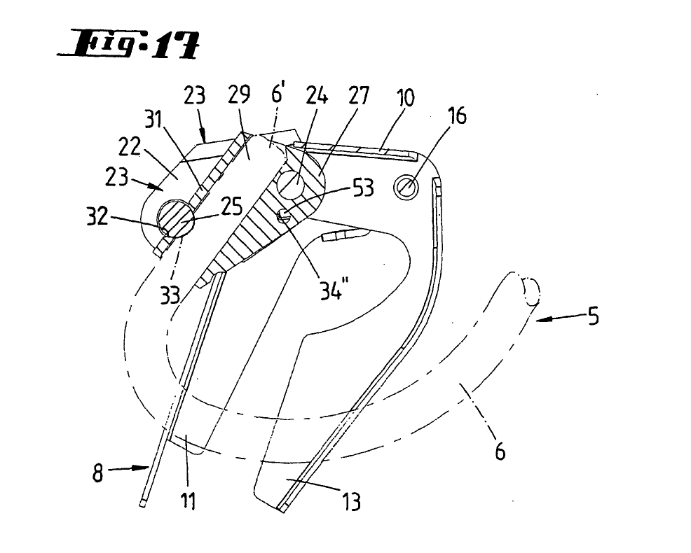

FIG. 21 shows a cross section through the adjustment mechanism of the rear seat headrest in accordance with the second embodiment, relating to the position of use of the headrest,

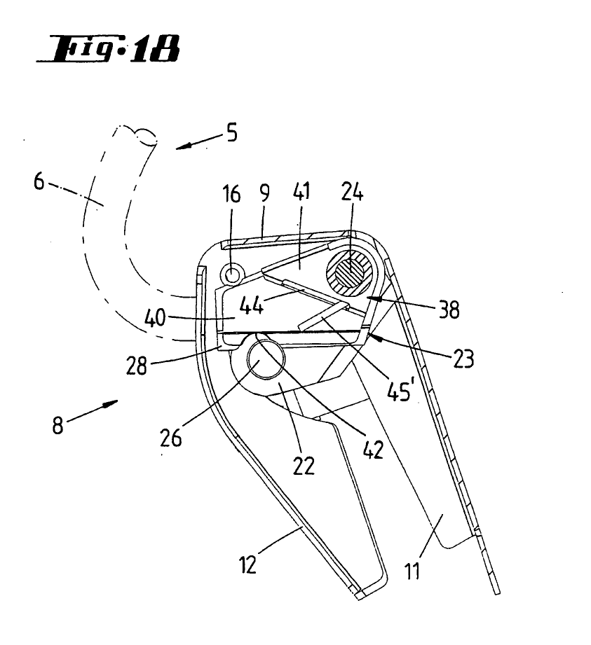

FIG. 22 shows an illustration similar to FIG. 21, but relating to the concealed position with associated loading of the spring,

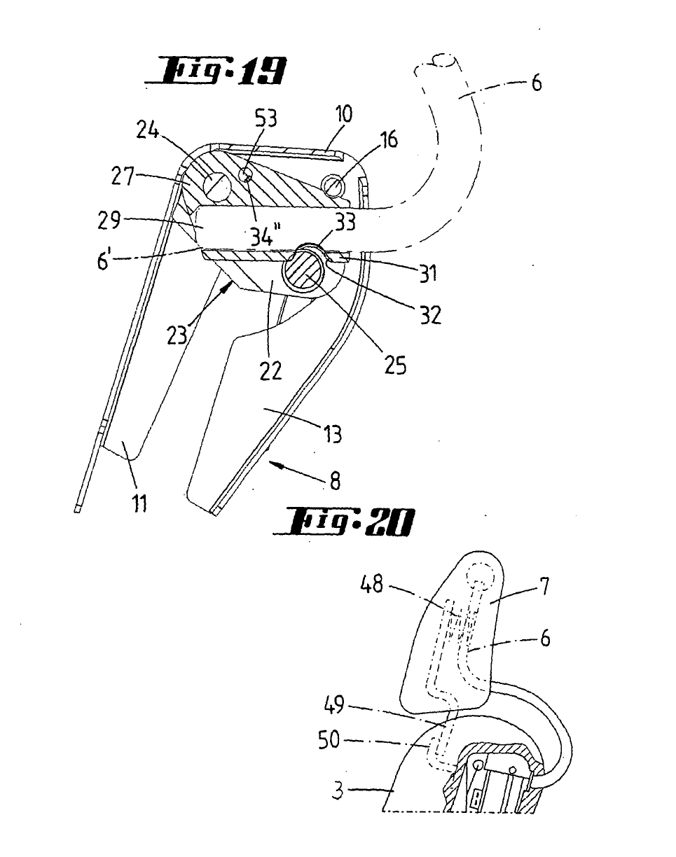

FIG. 23 shows a moment/rotation angle diagram illustrating the torque curves for the spring and the headrest,

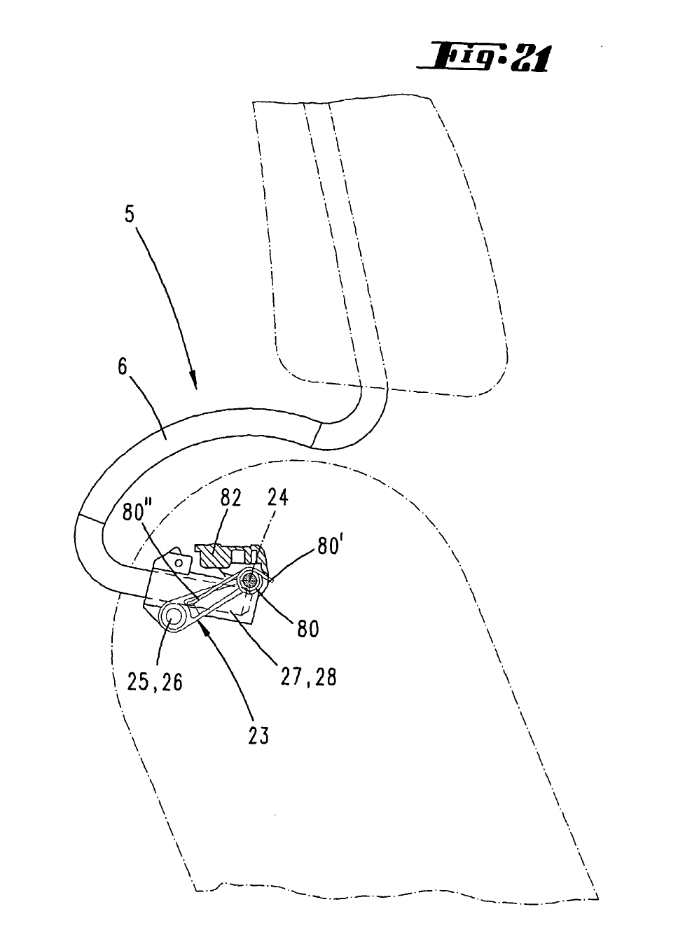

FIG. 24 shows a side view of the headrest holder which accommodates the holding brackets in the position of use of the headrest, which is indicated by dot-dashed lines relating to the third embodiment,

FIG. 25 shows a perspective illustration of the headrest holder,

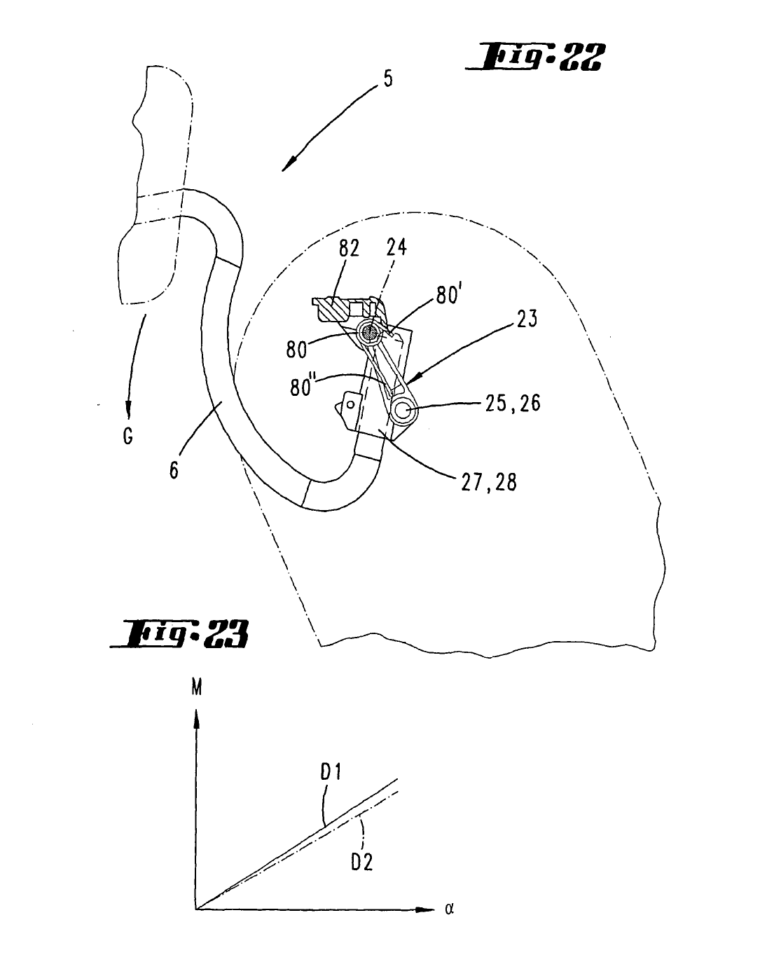

FIG. 26 shows a detailed illustration of a perspective holder for the spring, the overall profile of which is configured in a U shape,

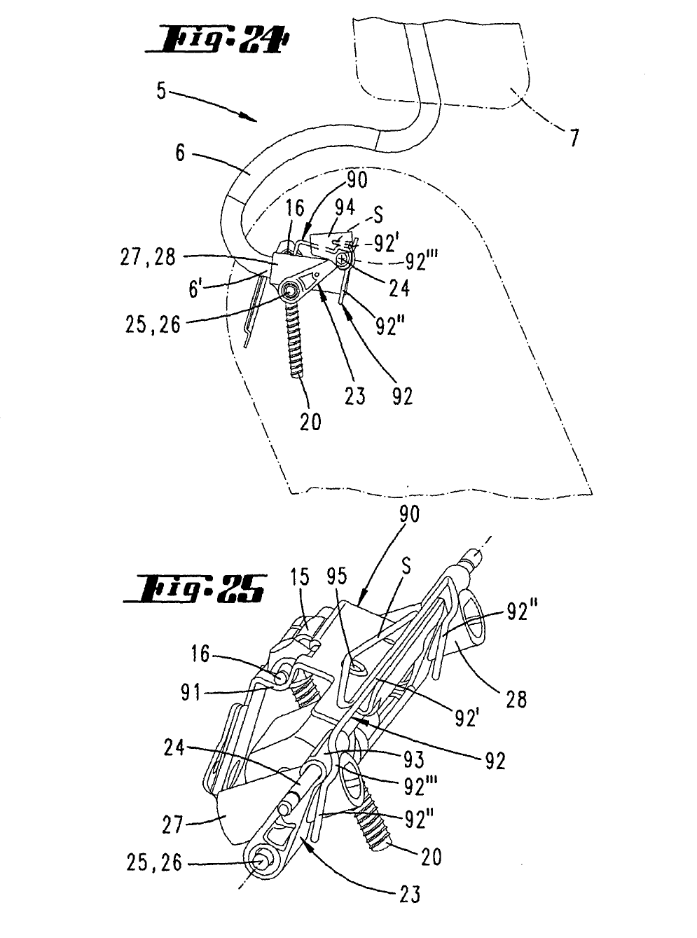

FIG. 27 shows a view of the spring,

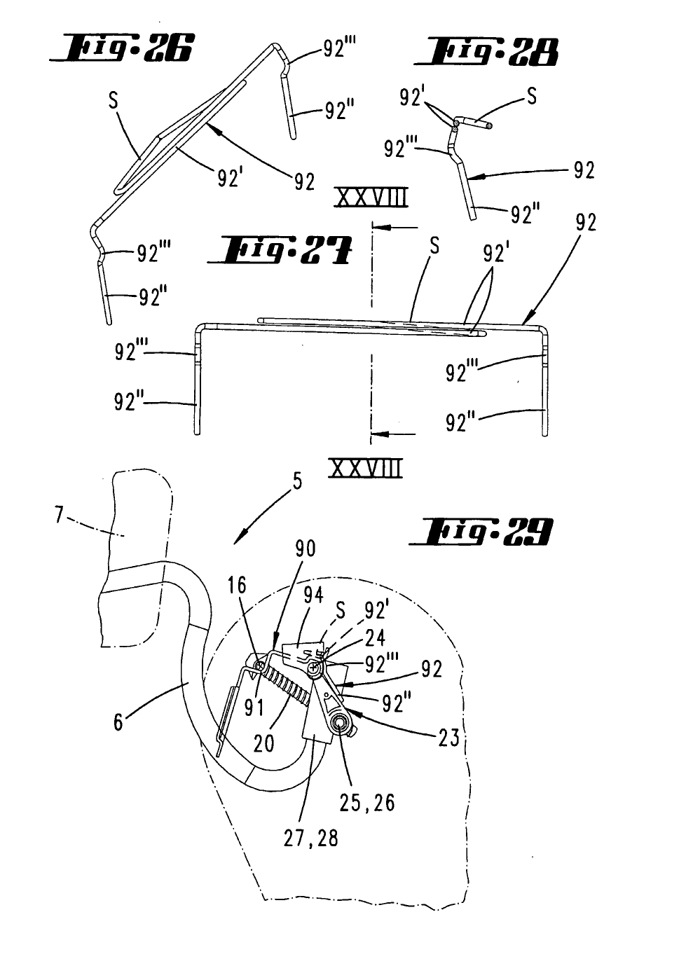

FIG. 28 shows the section on line XXVIII-XXVIII in FIG. 27, and

FIG. 29 shows an illustration corresponding to FIG. 24, but with the headrest having been moved into its concealed position, with associated loading of the spring.

According to the first embodiment of the rear seat headrest, in FIG. 1 reference numeral 1 denotes a driver's seat backrest. Behind it is the sitting surface 2 of a rear seat, which in accordance with the illustration shown in FIG. 1 is in a folded-forward position. A rear seat backrest 3 is associated with the sitting surface 2 of the rear seat. The rear seat backrest 3 can be folded forward about a folding axis 4 in order to adopt a horizontal position.

At its upper end, the rear seat backrest 3 carries a rear seat headrest, which is denoted overall by reference numeral 5. This rear seat headrest 5 has a cushion body 7, which is supported by two holding brackets 6 running parallel to one another, for supporting the back of the head of a person sitting on the rear seat. Each holding bracket 6 forms a rounded section R which flanks the top edge of the rear seat backrest and merges into an insertion section 6′.

The rear seat headrest is supported by a headrest holder 8. The latter has two bracket-like supporting elements 9, 10 which are disposed next to one another and from which mounting webs 11, 12 and 13, 14 respectively, are angled off. When seen in side view, in each case two mounting webs 11, 12 and 13, 14 complement one another to form a U shape. These mounting webs 11 to 14 are used to fix the headrest holder to the backrest frame (not illustrated).

The supporting element 10 is provided with an electric motor transmission 15 in the region of the mounting web 14. A drive shaft 16 mounted in the supporting elements 9, 10 can be made to rotate by means of this transmission 15. The drive shaft 16 engages through a U-shaped bearing bracket 17. The web of the U of this bearing bracket bearingly mounts a ring gear 18 which meshes with a bevel gear 19 fixed to the drive shaft 16. The ring gear 18 is seated in a rotationally fixed manner on one end of an externally threaded spindle 20. This spindle 20 engages through a spindle nut 21, which is configured as a sleeve-like supporting body. The ends of the spindle nut 21 extend between bearing lugs 22 of a pivot bearing 23 which is of U-shaped configuration. The pivot pin 24 of this pivot bearing 23 is seated in the supporting elements 9, 10. When the transmission 15 is initiated, the drive shaft 16 is set in rotation, which rotates the spindle 20 via the bevel gear transmission. As a result, depending on the direction of rotation, the spindle nut 21 is displaced in one direction or the other combined, at the same time, with the pivot bearing 23 being pivoted about the pivot pin 24.

As illustrated in FIG. 5, a spring 80, which is formed as a torsion spring, is seated on the pivot pin 24. The turns of this spring therefore surround the pivot pin 24. One limb 80′ is supported on the mounting web side, while the other, longer limb 80″ comes into contact with a protuberance 81 of the pivot bearing 23. This means that the spring opposes the force of the weight of the headrest when the latter is being moved into its concealed position.

Positively locking pins 25, 26, which engage through the bearing lugs 22 and project beyond the latter, are inserted into the two ends of the sleeve-like spindle nut 21. The free ends of the positively locking pins 25, 26 extend as far as the mounting web 14 or 11, respectively, which faces them. Holding receptacles 27, 28 interact with the positively locking pins 25, 26. These holding receptacles 27, 28 are likewise mounted on the pivot pin 24. In each holding receptacle 27, 28 there is a continuous insertion passage 29 for accommodating the associated insertion section 6′ of the holding bracket 6. The spacing between the insertion passages 29 corresponds to the spacing between the holding brackets 6. Each insertion passage 29 forms radially recessed free spaces F running in the longitudinal direction. These free spaces are delimited by radially protruding webs 30 running in the longitudinal direction.

In each case a concavity 32, which intersects the insertion passage 29, originates from the wall 31 of the holding receptacles 27, 28 which faces the positively locking pins 25, 26. A cutout 33 of matching shape in the insertion section 6′ is aligned with this concavity 32, so that a securing of the positively locking position can be achieved by means of the positively locking pins 25, 26. For this purpose, the holding receptacles 27, 28 on the pivot pin 24 are spring-preloaded in the direction of engagement against the positively locking pins 25, 26. The spring preloading results from in each case a torsion spring 34 which is located between the holding receptacle 27, 28 and the facing bearing lug 22 and is seated on the pivot pin 24. One end 34′ of this torsion spring is supported on a bent-out portion 35 of the bearing lug 22, while the other end 34″ of this torsion spring is supported on a transverse bore 53 of the holding receptacle 27, 28. A circuit board 36 which includes electronic components is provided in the region between the holding receptacle 27 and transmission 15. The respective position of the holding receptacles 27, 28 can be recorded by means of this circuit board 36, for example by means of sensor interrogation. Furthermore, to achieve an electrical line connection, a plug-connection passage 37 with the corresponding contacts is disposed adjacent to the electrical transmission 15.

A holding lever 38 is mounted around the pivot pin 24, between the mounting web 11 and the holding receptacle 28. The holding lever 38 is bent out of a sheet-metal blank to form a substantially U-shaped overall structure. Accordingly, the holding lever 38 has a web 39 with limbs 40, 41 angled off from the web. The limb 40 flanks the facing wide side wall of the holding receptacle 28. In the region of the concavity 32, the end of the limb 40 is provided with an angled-off bearing shell 42 which is fitted in a positively locking manner into a stepped-down section 26′ of the positively locking pin 26, cf. in this respect in particular FIG. 8. The bearing shell 42 and therefore also the holding lever 38 are held in position by the force of the springs 34.

The other limb 41 is likewise equipped with an angled-off portion 43. A cut-out window 44 is located there. One end 45′ of a return spring 45, which is seated on the pivot pin 24, is supported on one narrow edge of the window. The other end 45″ of the return spring 45 is supported, under preload, against the web 39 of the holding lever 38. This holding lever therefore serves to supplement a positively locking pin in order to secure a holding bracket 6 in a positively locking manner.

The force of the return spring 45 is such that it is greater than the spring force acting on the holding receptacles, i.e. the force of the torsion springs 34.

As shown in FIG. 1, the cushion body 7 includes a drive 60, which is illustrated by hidden lines. The drive 60 may be an electric motor which is associated, via a toothed drive (not shown), with the end of one holding bracket 6. Accordingly, initiation of the drive 60 can cause the cushion body 7 to be displaced in the vertical direction illustrated by arrows, so that the headrest is provided with an additional degree of freedom.

The following method of operation is established: In accordance with FIG. 1 to 8, the pivot bearing 23 is made by the spindle drive to adopt a 0° position. Correspondingly, the holding receptacles 27, 28 supported by the positively locking pins 25, 26 are also in a ⁰° position, which corresponds to the position of use of the headrest.

When the rear seat is not occupied, to provide the driver with an improved rear view, the rear seat headrest 5 is moved into a concealed position, with the cushion body 7 moving into a hollow 46 in a parcel shelf 47, cf. dot-dashed illustration in FIG. 1. This movement may be effected automatically or may be initiated by the driver. During this movement, an intermediate position as shown in FIG. 9 to 11 occurs.

In this position, the pivot bearing 23 has been rotated through approx. 90° about the pivot pin 24 by means of the spindle drive. This movement is also executed by the holding receptacles 27, 28 on account of their spring loading. As shown in FIG. 10, the end 45′ of the return spring 45 has also moved into contacting abutment against the mounting web 11. In the 90° position of the holding receptacles 27, 28, the cushion body 7 is accommodated by the hollow 46 in the parcel shelf 47. In association with the displacement of the rear seat headrest into the concealed position, the spring 80 is stressed or loaded by means of the protuberance 81 of the pivot bearing 23. The torque which results from the force of the weight of the headrest in this case opposes the moment of the spring 80, so that the drive 15 substantially has to overcome the friction in the adjustment mechanism. Accordingly, the drive 15 can be relatively weak and space-saving in terms of its dimensions. The spring 80, which acts in the manner of a force accumulator, during a pivoting of the rear seat headrest out of the concealed position into the position of use, assists with the pivoting displacement, and consequently only a small amount of force is required for this movement as well. Once the cushion body 7 has been accommodated by the hollow 46 in the parcel shelf 47, the spindle drive continues its adjustment, pivoting the pivot bearing 23 further about the pivot pin 24. On account of the fact that the return spring 45 is stronger than the torsion springs 34, the positively locking pins 25, 26 accordingly move into a spaced-apart position with respect to the holding brackets 6. However, on account of the return spring 45 being under stress, the holding lever 38 remains in engagement, by means of its bearing shell 42, with the associated holding bracket 6, cf. FIG. 12 to 14. It is then possible to bring about the position illustrated in FIG. 1, in which the seat surface 2 is folded forward. The rear seat backrest 3 is then to be folded down. On account of the return spring 45, in the final phase of the folding-down displacement of the backrest 3, the headrest 5 can be moved into a position in which it can be pushed over, so that the headrest 5 has also been moved through approximately 125°, cf. FIG. 15 to 17.

If the headrest 5 is in its concealed position and a person sits down on the seat surface 2 of the rear seat, the headrest 5 moves into the position of use, which is effected, for example in conjunction with the seat being occupied and the catch of the seatbelt actuated. In this case, the headrest is displaced by means of the spindle drive, specifically by the drive shaft 16 rotating in the opposite direction.

Within certain limits, it is possible for adjustments to the headrest in the position of use to be carried out under automatic or manual control. If automatic adjustment of the headrest is desired, it is recommended for a drive 60 to be provided within the cushion body 7. This drive 60 may be an electric motor which allows the cushion body 7 to be adjusted in the direction of the arrow illustrated in FIG. 1 by means of a worm and toothed gear (not shown). An extended position of the cushion body 7 is illustrated by dot-dashed lines. If a person sitting on the rear seat leaves his place, the drive 60 can be made to move the cushion body 7 back into its base position by means of a seat occupancy detection. This is required in particular if the cushion body is then pivoted back into the concealed position. However, it is also possible for the two movements to be carried out in a superimposed combination.

If the headrest 5 is to be detached from the rear seat backrest, starting from the position of use, the spindle drive should be initiated, in such a manner that, with the headrest held in place, the pivot bearing 23 with the associated positively locking pins 25, 26 is moved away only by a few degrees, as illustrated in FIGS. 18 and 19. The positive lock with respect to the insertion sections 6′ of the holding brackets 6 is eliminated as a result, so that the holding brackets 6 can be pulled out of the holding receptacles 27, 28.

Loading forces which act on the headrest 5 in the position of use are transmitted via the holding brackets 6 into the positively locking pins 25, 26 and into the spindle nut 20 and pivot bearing 23, which forces are absorbed by the supporting elements 9, 10 via the pivot pin 23. Therefore, the electric motor drive 15 remains unaffected by any high loads.

FIG. 20 shows an alternative configuration of the headrest. The cushion body 7 is connected to the holding brackets 6 in a pivotably movable fashion. Furthermore, the cushion body 7 is spring-preloaded into a stop position. This is effected by means of a spring 48 which acts on a stop bracket 49. The latter is supported against a pivot stop 50 on the backrest side. During the displacement of the headrest 5 by means of the spindle drive, it is then additionally possible to perform individual adaptation of the cushion body 7.

In accordance with the second embodiment shown in FIGS. 21 and 22, the supporting frame is denoted by reference number 82. The pivot bearing 23 can be displaced about the pivot pin 24 thereof. In this case, as in the first embodiment, the displacement can be effected by means of a spindle drive (not shown). The pivot bearing 23 supports a positively locking pin 25, 26 associated with the holding receptacle 27, 28. The spring 80, which is configured as a torsion spring, is seated on the pivot pin 24. The turns of this spring 80 are wrapped around the pivot pin 24. One limb 80′ of the spring is supported on the supporting frame 82, while the other limb 80″ of the spring acts on the pivot bearing 23 as a torque acting in the clockwise direction.

If the rear seat headrest is pivoted out of its position of use illustrated in FIG. 21 into the concealed position shown in FIG. 22, the weight force G in FIG. 22 is opposed by the spring 80. Accordingly, this too acts as a force accumulator spring. This means that in this embodiment too, the spring 80 has an assisting effect during the return of the headrest out of the concealed position into the position of use. This leads to the advantage that in this case too the drive substantially only has to overcome the friction of the adjustment mechanism.

The moment/rotation angle diagram shown in FIG. 23 illustrates that the spring moment which results from the spring 80 exceeds the moment resulting from the weight force at least over part of the pivoting travel. The torque curve of the spring is denoted by letter D₁ while the torque curve D₂, resulting from the weight of the headrest, is slightly below D₁. This measure may prove advantageous after prolonged use, since the effect of the spring will naturally deteriorate to some extent.

In accordance with the third embodiment, shown in FIGS. 24 to 29, the headrest holder is denoted by reference numeral 90. This holder is stamped out of metal sheet and converted into the appropriate shape by bending. Formed integrally on the holder 90 is a bearing hollow 91, open on one side, which is used for the drive shaft 16, the electric motor transmission 15 acting on said drive shaft 16. On account of the loosely resting drive shaft 16, which drives the spindle 20 via the bevel gear transmission (not shown in more detail), the spindle is mounted with movement play with respect to the holder 90, which makes it possible to compensate for installation tolerances.

The holder 90 therefore carries the pivot pin 24 about which the pivot bearing 23 can be displaced during the pivoting. Opposite the pivot bearing 24, the pivot bearing 23 accommodates the positively locking pins 25, 26, which for their part interact with the holding receptacles 27, 28.

According to this version, there is likewise a spring 92 which operates as a force accumulator spring. The overall profile of this spring 92, as can be seen in particular from FIGS. 26 and 27, is U-shaped, comprising the web 92′ of the U and the two limbs 92″ of the U. It can be seen from FIG. 27 that the web 92′ of the U is approximately three times the size of the limbs 92″ of the U. The web 92′ of the U is in this case increased in size with respect to the active spring length by being routed in a loop. The loop S in question is substantially configured as an obtuse-angled triangle, with the hypotenuse facing the web 92′ of the U.

Close to the bend into the web 92′ of the U, the limbs 92″ of the U each have a formation 92′″ by means of which they partially enclose a sleeve 93 surrounding the positively locking pins 25, 26. The spring 92 is rotationally secured by the loop S. The loop S engages against the holder 90. A covering 94 engages over the loop S. A securing screw (not shown) which engages in a threaded bore 95 in the headrest holder 90 can be used to secure the covering 94. On its way into this position, the securing screw passes through the loop S.

As can be seen from FIG. 24, in the position of use of the headrest, there is a movement play between the limbs 92″ of the U and the pivot bearing 23. This means that when the headrest is being moved into the concealed position, the limbs 92″ are only acted on after passing through this movement play, after which the loading of the force accumulator begins, as in the embodiment described above. When the headrest is being returned out of the concealed position into the position of use, the loaded force accumulator spring 90 then has an assisting effect, so that in this version too the drive substantially only has to overcome the friction of the adjustment mechanism.

However, it is also possible, in the position of use of the headrest, for the U limbs 92″ already to be engaging against the pivot bearing 23.

All features disclosed are (inherently) pertinent to the invention. The disclosure content of the associated/appended priority documents (copy of the prior application) is hereby incorporated in its entirety in the disclosure of the application, partly with a view to incorporating features of these documents in claims of the present application.

1-29. (cancelled)

30. Rear seat headrest (5) with adjustment mechanism for motor vehicles, wherein the headrest (5) can be pivoted about a pivot pin (24) out of a position of use into a concealed position using a weight force which is active on account of a weight of the headrest, and can be displaced by motor means at least out of the concealed position into the position of use, and wherein there is a spindle drive (20, 21) for displacing the headrest (5).

31. Rear seat headrest according to claim 30, wherein the weight force of the headrest (5) is opposed by a spring (80, 92).

32. Rear seat headrest according to claim 31, wherein a spring moment (D₁) of the spring (80, 92) exceeds a moment (D₂) resulting from the weight force at least over part of a pivoting travel.

33. Rear seat headrest according to claim 31, wherein the spring (80, 92) comprises a torsion spring or a torsion bar or a tension spring or a compression spring.

34. Rear seat headrest according to claim 31, wherein the spring (80) is wound around the pivot pin (24).

35. Rear seat headrest according to claim 30, wherein the spindle drive (20/21) acts on the headrest (5) at a transverse spacing from the pivot pin (24).

36. Rear seat headrest according to claim 30, wherein the headrest (5) has holding brackets (6) that are secured in position by means of positively locking pins (25, 26), and wherein the spindle drive (20/21) acts on the holding brackets (6) by means of the positively locking pins (25, 26).

37. Rear seat headrest according to claim 36, wherein the spindle drive includes a spindle nut (21), in which the positively locking pins (25, 26) are also secured.

38. Rear seat headrest according to claim 36, wherein the positively locking pins (25, 26), in the concealed position, can be controlled so as to adopt a spaced-apart position with respect to the holding brackets (6).

39. Rear seat headrest according to claim 36, wherein the headrest (5) or its brackets (6) can be pivoted further in the direction of the positively locking pins (25, 26) in the event of a backrest (3) on which the headrest (5) is mounted being folded down.

40. Rear seat headrest according to claim 30, wherein a further pivoting takes place counter to the force of a return spring (45).

41. Rear seat headrest according to claim 36, wherein the holding brackets (6) are inserted into holding receptacles (27, 28).

42. Rear seat headrest according to claim 41, wherein the holding receptacles (27, 28) on the pivot pin (24) are spring-preloaded in a direction of engagement against the positively locking pins (25, 26).

43. Rear seat headrest according to claim 36, wherein a further pivoting takes place counter to the force of a return spring (45), and the force of the return spring (45) is greater than the spring force acting on the holding receptacles (27, 28).

44. Rear seat headrest according to claim 41, wherein the holding receptacles (27, 28) form insertion passages (29) for the holding brackets (6), which insertion passages (29) have radially recessed free spaces (F) running in the longitudinal direction.

45. Rear seat headrest according to claim 36, wherein there is a holding lever (38) which supplements a positively locking pin (26) in order to secure a bracket (6) in a positively locking manner.

46. Rear seat headrest (5) according to claim 36, wherein the headrest (5) has a cushion body (7) which is connected to the holding brackets (6) in a pivotably moveable manner, wherein the cushion body (7) is spring-preloaded into a stop position, and in that during the displacement of the headrest (5) the cushion body (7) can be adjusted by engaging against a pivot stop (5).

47. Rear seat headrest (5) with adjustment mechanism for motor vehicles, in which the headrest (5) can be pivoted about a pivot axis (24) out of a position of use into a concealed position in a manner which can be triggered automatically, and can be moved out of the concealed position into the position of use, and wherein a cushion body (7) of the headrest (5) can be displaced separately by means of a drive (60).

48. Rear seat headrest according to claim 47, wherein an electric motor which forms the drive (60) for displacing the cushion body (7) is disposed within the cushion body.

49. Rear seat headrest according to claim 47, wherein the headrest (5) can only be displaced into the concealed position when the cushion body (7) is in a starting position.

50. Rear seat headrest according to claim 47, wherein the weight force of the headrest (5) is opposed by a spring (80, 92), and an the overall profile of the spring (92) is of U-shaped configuration.

51. Rear seat headrest according to claim 50, wherein a web (92′) of the U is longer than limbs (92″1) of the U.

52. Rear seat headrest according to claim 51, wherein the web (92′) of the U is enlarged by means of looped routing with respect to an active spring length.

53. Rear seat headrest according to claim 50, wherein the spring (92) is secured against rotation in the region of a loop (S).

54. Rear seat headrest according to claim 30, wherein the spindle drive (20) is mounted with movement play with respect to a holder (90) of the headrest.

55. Rear seat headrest according to claim 54, wherein the headrest (5) pivots together with the holder.

56. Rear seat headrest according to claim 37, wherein the spindle nut is driven relative to a stationary spindle.

57. Rear seat headrest according to claim 41, wherein an insertion section (6′) is secured in position by a securing spring disposed on the holding receptacle (27, 28).

58. Rear seat headrest according to claim 57, wherein the securing spring can be displaced into a release position with motor assistance.
